(19) United States
(12) Patent Application Publication
(10) Pub. No.: US 2021/0390424 A1
(43) Pub. Date: Dec. 16, 2021

(54) CATEGORICAL INFERENCE FOR TRAINING A MACHINE LEARNING MODEL

(71) Applicant: AT&T Intellectual Property I, L.P., Atlanta, GA (US)

(72) Inventors: Chris Vo, Sachse, TX (US); Vijayan Nagarajan, Plano, TX (US); Jeremy Fix, Acworth, GA (US); Robert Woods, JR., Plano, TX (US)

(73) Assignee: AT&T Intellectual Property I, L.P., Atlanta, GA (US)

(21) Appl. No.: 16/897,471

(22) Filed: Jun. 10, 2020

(51) Int. Cl. G06N 5/04; G06N 20/00; G06Q 30/00

(52) U.S. Cl. CPC G06N 5/04; G06Q 30/0185; G06N 20/00

(57) ABSTRACT

Aspects of the subject disclosure may include, for example, training a machine learning model on training data, generating, by the machine learning model, a plurality of prediction data records which each has an associated probability, and promoting prediction data records of the plurality of prediction data records having an associated probability exceeding a threshold. The subject disclosure may further include combining the promoted prediction data records with the training data to form new training data, retraining the machine learning model on the new training data and generating, by the machine learning model, new prediction data records. The subject disclosure may further include identifying a real-time condition based on the new prediction data records, the real-time condition being one that requires prompt attention, and resolving the real-time condition. Other embodiments are disclosed.

### FIELD OF THE DISCLOSURE

The subject disclosure relates to a method and apparatus for multiple pass training, prediction and retraining of a machine learning model.

### BACKGROUND

Machine learning models are commonly used to respond to a variety of conditions and control real-world processes. Such machine learning models require training and re-training. Conventional machine learning models are trained using a single pass with historical training data. However, the historical training data may not include attributes that were recently introduced.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A illustrates an example, non-limiting embodiment of exemplary data for use in a machine learning model that may be used in conjunction with a system functioning within the communication network of FIG. 1 in accordance with various aspects described herein.

FIG. 2B shows a second, non-limiting example of data for use in a machine learning model that may be used in conjunction with a system functioning within the communication network of FIG. 1.

FIG. 2C is a flow diagram illustrating an example, non-limiting embodiment of a method of operation of categorical inference for training a machine learning model in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for multiple pass training, prediction and re-training of a machine learning model to extract insights from large collections of data. Prediction data having predicted probabilities approximating the binary positive and negative, peers of data values can yield additional insights not otherwise available. The promotion of binary class values can be controlled by variable threshold values to reduce unintended bias in the machine learning model. Other embodiments are described in the subject disclosure.

One or more aspects of the subject disclosure include training a machine learning model on training data, generating, by the machine learning model, a plurality of prediction data records, each prediction data record of the plurality of prediction data records having an associated probability, and promoting prediction data records which have an associated probability exceeding a threshold to form promoted prediction data records. The subject disclosure may further include combining the promoted prediction data records with the training data, forming new training data, re-training the machine learning model on the new training data and generating, by the machine learning model, new prediction data records. The subject disclosure may further include identifying a real-time condition based on the new prediction data records, wherein the real-time condition is one that requires prompt attention, and resolving the real-time condition.

One or more aspects of the subject disclosure include training a machine learning model with training data, the training data including a plurality of data records, applying testing data to the machine learning model in a first pass to generate first-pass prediction data records that each have a respective associated probability value, and selectively promoting first pass prediction records in response to a respective associated probability value exceeding a threshold, producing promoted prediction records. The subject disclosure can further include combining the promoted prediction records with at least some data records of the training data, producing new training data, training the machine learning model with the new training data and applying at least a portion of the testing data to the machine learning model in a second pass to generate second pass prediction data records that each has a respective associated second pass probability value. The subject disclosure can further include combining respective second pass prediction data records with respective first pass prediction data records to form prediction result records.

One or more aspects of the subject disclosure include receiving, by a processing system including a processor, data for a plurality of interactions, selecting a first set of the data to forming training data, the training data including a plurality of data records, and selecting a second set of the data to form testing data. The subject disclosure can further include training a machine learning model with the training data, applying the testing data to the machine learning model in a first pass to generate first pass prediction records, each respective first pass prediction record having a respective associated probability value. The subject disclosure can further include comparing respective associated probability values of respective first pass prediction record with one or more cutoff thresholds and promoting respective first pass prediction records in response to the comparing, producing an affected fragment of prediction records. The subject disclosure can further include combining the affected fragment of prediction records with at least some data records of the training data to produce new training data and training the machine learning model with the new training data. The subject disclosure can further include applying at least a portion of the testing data to the machine learning model in a second pass to generate second pass prediction data records, each respective second pass prediction data record having a respective associated second pass probability value. The subject disclosure can further include combining respective second pass prediction data records with respective first pass prediction data records to form prediction result records.

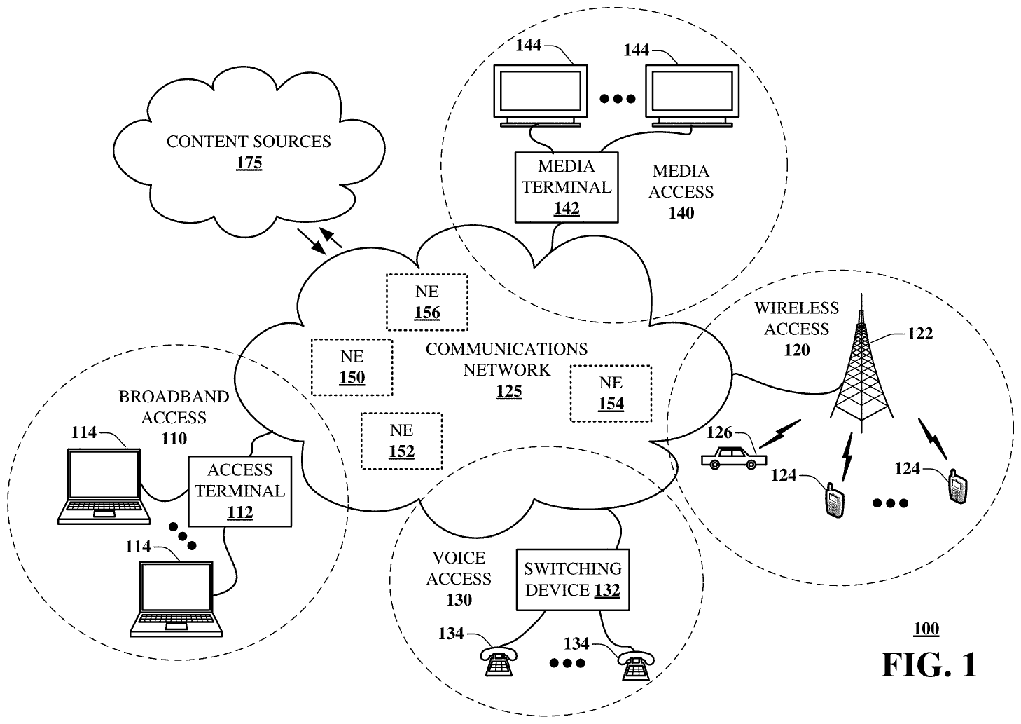

Referring now to FIG. 1, a block diagram is shown illustrating an example, non-limiting embodiment of a system 100 in accordance with various aspects described herein. For example, system 100 can facilitate in whole or in part implementing a machine learning model to generate predictions about a real-world system, identify a problem requiring resolution, and resolve the problem. In particular, the system 100 can facilitate multiple pass training and prediction in a machine learning model, including selectively promoting predicted data records having a prediction possibility close to binary true and false values, and using the promoted records to enrich the training data for a second pass and subsequent passes through the machine learning model. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

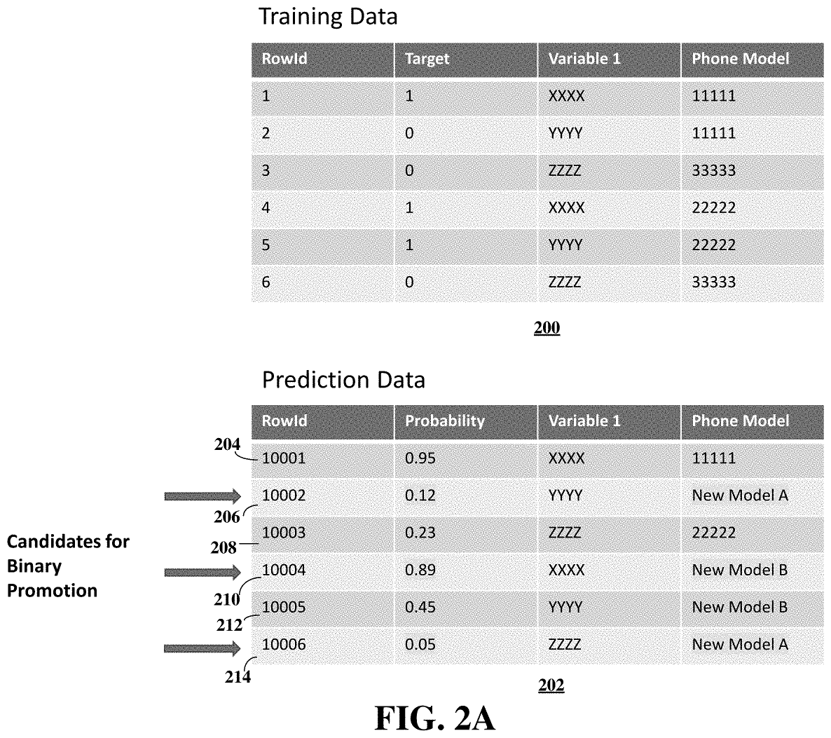

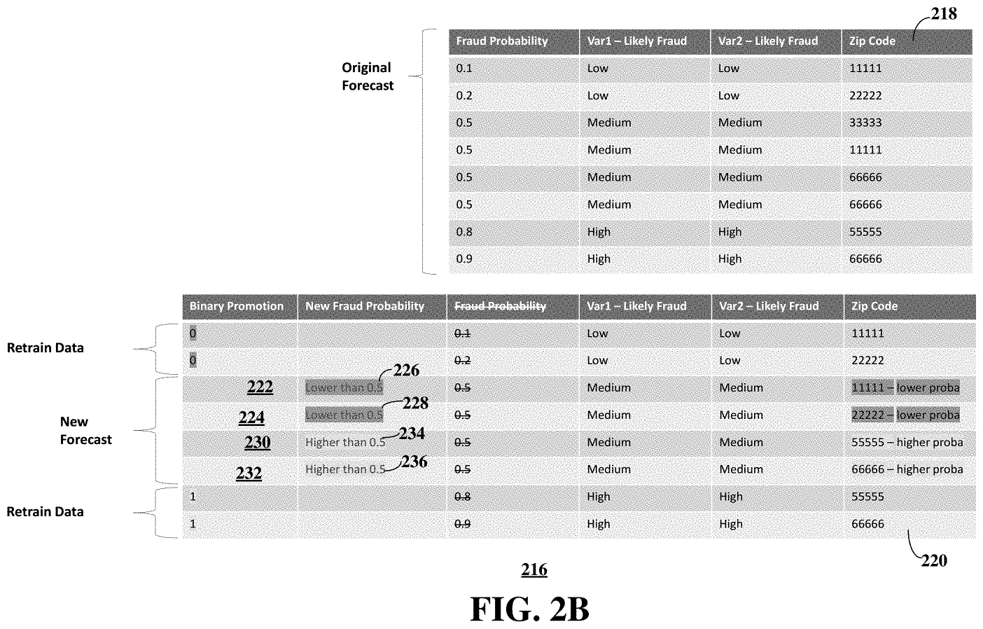

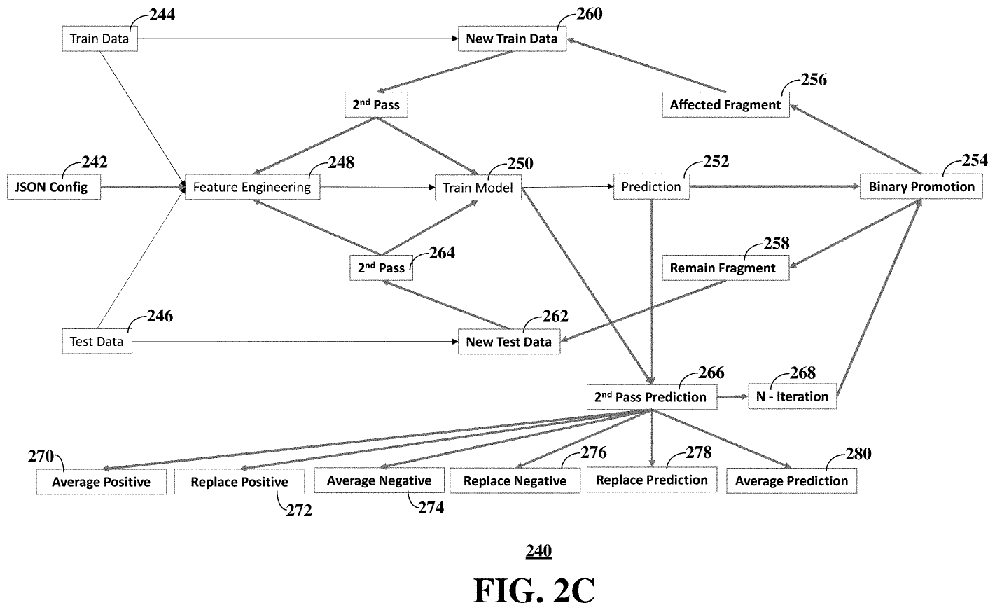

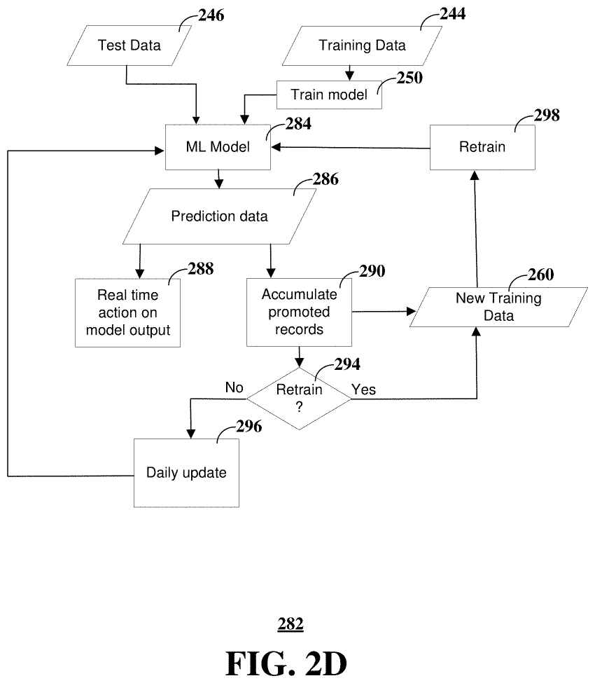

FIG. 2A illustrates an example, non-limiting embodiment of exemplary data for use in a machine learning model that may be used in conjunction with a system functioning within the communication network of FIG. 1 in accordance with various aspects described herein.

Machine learning (ML) models may be used to predict real-world effects based on historical data. The ML model may be based on a number of attributes for the system that is modelled. The historical data may be used as training data to train the ML model. After training, current data may be applied to the ML model to produce a result or a decision or a prediction. The decision or prediction may be a binary option or result.

One example uses historical information about subscribers to communication services to determine if current subscribers will continue with the communication service in response to a change. Examples of such communication services include cellular telephone service, cable television service, online streaming services for video, music and games, and other services. One example of a change is introduction of a new cellular telephone model by a service provider, or by a competitor of a service provider. The service provider may wish to predict how many current subscribers will remain subscribers upon the introduction of the new cellular telephone model. Customers changing subscribers may be referred to as churn. ML models may be used to predict occurrence of churn.

In another example, historical data about subscribers to communication services may be used by service provider or retailer of equipment to predict fraudulent behavior involving equipment or services. It is known that some consumers will misrepresent their intention during a transaction with the communication service provider. Such misrepresentation may be considered fraudulent and is preferably detected or predicted early to counter the fraud or prevent future fraud. ML models may be used to predict occurrence of fraud. ML models may be used in many other examples, as well.

The prediction produced by the ML model may be used to control external responses. For example, if fraudulent behavior may be predicted for purchasers in certain postal codes, the packaging may be adjusted for cellular telephone sold in those areas, or additional controls or limitations may be placed on customer accounts to prevent the actual occurrence of fraud. Similarly, if a ML model predicts a relatively high level of churn in response to a change such as a new phone on the market, a service provider may respond by offering different products, features or services. With a reliable prediction from the ML model, suitable responses may be developed. Some of the responses may be implemented in real-time, or near real-time, to prevent further fraudulent behavior, for example. Other responses may be implemented over time, such as predicting and responding to customer churn.

Conventionally, a single-pass training ML model has been used. That is, suitable historical data have been identified and used as training data for the ML model. Following training, the ML model is used in a production environment. The ML model may be retrained over time, using new training data. The training data should include all attributes needed to determine a prediction by the model. Attributes of interest will depend on the subject of the ML model. Examples include geographical information or demographic information about persons, or information about behavior by persons. Attributes in the ML model may be given binary values so that an attribute has a value of 1 or a value of 0 in evaluating the model.

However, if developers of the ML model use a traditional single-pass modeling apparatus with variables imbalance datasets, the developers may miss key insight dues to missing data attributes during the model training phase. The historical training data might not contain attributes that were recently introduced. An example of such an attribute in the context of communication services is a new phone model that has become commercially available. Another example is data about customer orders that come from postal codes or zip codes that were not previously captured.

For example, if a service provider begins promoting a new product or service in particular areas, the ML model may not receive training data about zip codes where customer churn occurred until after the promotion. At that time, it may be too late, in a business sense, to respond. However, other attributes may correlate with churn. The correlation may not be perfect, but approximate. For example, if an existing customer has a probability 0.89 of churn using historical data, data for that customer may be of value in conjunction with a model that uses zip code information to predict customer churn, even where data for the zip code attribute is not yet available. The zip code for the existing customer may not yet reveal the propensity to churn, but the other historical factors do reveal the propensity. By adding that existing customer to the training data immediately, by in effect rounding up his prediction probability to 1.0, the existing customer's other attributes, such as zip code, are also added to the training data, thereby expanding the training data and revealing other trends within the training data.

Where prediction data has a high probability, such as 0.89, of producing the result, such as customer churn, the system and method in accordance with the subject disclosure will promote that attribute to have a binary prediction attribute, such as probability of 1. By promoting prediction entries with high probability values to binary class 1, the training dataset can be expanded. Similarly, prediction entries with low probability values may be promoted to binary class 0 to further expand the dataset. Still further, the ML model can be retrained with the expanded dataset. The result will be to expose more insight by taking into account both increased data volume, such as more data records, and the new variable attributes. In effect, predicted data is promoted based on the prediction value and used to re-train the ML model as if the predicted data was real, historical data.

In the past, use of prediction data to supplement historical data has been avoided. It was thought that use of such data may introduce a bias in the data, due to assumptions about which prediction data to use. Generally, introduction of bias into data is to be avoided. However, by careful control of threshold levels at which historical data are promoted, an acceptable level of bias may be maintained while realizing certain advantages.

The technical advantages provided by the noted process are substantial. First, the noted process operates to improve a forecast by an ML model by exposing and leveraging new variable attributes not found for traditional single-pass machine learning algorithms. Further, the noted process permits leveraging new insights that can be inferred through multiple prediction and retrain iterations. In effect, each iteration of model training can be bootstrapped by new insights gained from prior iterations. Still further, the noted process can provide a proactive indication for models needing to retrain due to meaningful new attributes recently introduced. For example, the model can receive as a batch all the forecast entries for a period of time, such as daily, weekly, etc. If a resulting new accuracy score increased, that may serve as an indication to retrain the model since the new data are meaningful.

By way of further introduction, FIG. 2A shows exemplary training data 200 for a machine learning model related to cellular telephone data. In particular, the training data 200 may be used to evaluate effects of introduction of two new cellular telephone models, referred to as New Model A and New Model B. The training data 200 are historical data and relate to, for example, past occurrence of customer fraud. Similar data may exist or be presented with a relation to customer churn.

FIG. 2A shows a table with six rows of data labelled 1 through 6. Each row represents an independent record for a customer and the row labels correspond to a unique record identifier. The data relate to three existing phone models, model number 11111, model number 22222 and model number 33333. In the example of FIG. 2A, phone model number is illustrated has having a connection with occurrence of fraud because, in this example, the service provider has information about phone models and the existence of fraud. In other examples, instead of phone model, the service provider may have information about postal codes or telephone area codes for customers.

The training data 200 also includes data associated with another variable, designated in FIG. 2A as variable 1. Variable 1 may be any other collection of data about customers. Variable 1 may represent any number of other variables.

The training data 200 includes a column labelled Target which has a binary value, including binary class 1 and binary class 0. Binary class 1 in this example corresponds to occurrence of customer fraud. Binary class 0 corresponds to no occurrence of customer fraud. The first entry, with record identifier or Row ID 1, has a Target value of 1 indicating fraud has occurred in connection with phone model number 11111. The second entry, with record identifier or Row ID 2, has a Target value of 0, indicating no fraud has occurred, also in connection with phone model 11111. The training data 200 includes no information about New Model A or New Model B because those models are new and have just been introduced.

FIG. 2A further shows prediction data 202. The prediction data 202 are newly generated data from transactions by the cellular service provider and customers. In one example, a customer entered a retail store of the service provider and requested to replace the subscriber identity module (SIM) of the customer's cell phone. Ultimately, the transaction was deemed to be fraudulent in nature. Data about the transaction is collected in a record in prediction data 202. The predication data includes a prediction value for whether or not consumer fraud will occur in connection with this transaction. The predication may be based on the customer's identity and the service provider's experience with the customer, over the past 30 days or over a different interval. The prediction value is a prediction whether the SIM replacement request is fraudulent. The prediction data 202 may include information about customers and new cell phone purchases, including purchases of two newly introduced models, New Model A and New Model B.

The prediction data 202 includes six rows or six records. Each record is identified by a record identifier or Row ID, including record 204, record 206, record 208, record 210, record 212 and record 214. The first row, record 202 with record identifier 10001, shows that, based on training data 200, a phone model 11111 along with variable 1 having a value of XXXX, has a probability of 0.95 of consumer fraud occurring. There may be other variables or information not part to the data here that keep the fraud probability of record 204 from being 100 percent.

In accordance with an embodiment, the record 204 with record identifier 10001 and probability of 0.95, is added to the training data 200 and given a target value of 1. The record 204 is then used to retrain the ML model. Because the probability for record 204 is relatively high, the value is in effect rounded-up to a probability of 1.0 and used for retraining the ML model. The record 205 is promoted to binary class 1.

Similarly, record 206, with Row ID value 10002, shows a fraud probability of 0.12 in connection with a transaction involving a phone of model New Model A. Because the determined probability is relatively low, the value 0.12 may be rounded down to a value of 0 as the target value and record 206 may be added to the training data 200. The record 206 is promoted to binary class 0.

Similarly, record 210, with a Row ID value 10004, shows a fraud probability of 0.89 in connection with a transaction involving a phone of model New Model B. Because the determined probability is relatively high, the value of 0.89 may be rounded up to a value of 1 as the target value and record 210 may be added to the training data 200. The record 210 is promoted to binary class 1.

Similarly, record 214, with Row ID value 10006, shows a fraud probability of 0.05 in connection with a transaction involving a phone of model New Model A. Because the determined probability is relatively low, the value 0.05 may be rounded down to a value of 0 as the target value and record 214 may be added to the training data 200. The record 214 is promoted to binary class 0.

In accordance with some embodiments, not all values are rounded up or down, and not all records are added to the training data. For example, record 208, with Row ID value 10003, has a probability value of 0.23, indicating only a 23 percent probability of a fraudulent transaction. Also, record 212 with Row ID value 10005 has a probability of 0.45, indicating only a 45 percent probability of being a fraudulent transaction. Because the probability value is neither high enough nor low enough to be confidently assessed as fraudulent or not, the records 208 and 212 are not added to the training data.

In accordance with some embodiments, one or more thresholds are established so that only records having a probability value above a top threshold, such as 0.85, or a probability below a bottom threshold, such as 0.15, are promoted and used as training data on a second pass operation to train the ML model.

In some embodiments, the method and apparatus operate to promote prediction entries with high probability to binary class 1 and adding the associated records to the training data 200 to form augmented training data. In some other embodiments, prediction entries having a relatively low probability are promoted to probability class 0. In some other embodiments, both promotion based on probability value in prediction data may be used. By promoting prediction entries with high probability to binary class 1, or promoting prediction entries with low probability to binary class 0, or both, and retraining the ML model with the expanded dataset, the ML model can expose more insight by taking into account both increased data volume, meaning more records in the augmented training data 200, and the new variable attributes. In this case, the New Phone Model A and New Phone Model B could give valuable insight.

FIG. 2B shows a second example of prediction data 216 for use in a machine learning model. FIG. 2B shows initial prediction data 218 before promoting some records and subsequent prediction data 220 after promoting records and retraining on the augmented training data. The effect of promoting certain records based on prediction values will be to adjust prediction data for related records.

The initial prediction data 218 shows likelihood of fraud based on postal code or zip code. The data in this example are organized in 8 records. Each record has a respective fraud probability, a first variable labelled Var1 value related to the likelihood of a fraudulent transaction, a second variable labelled Var2 value related to the likelihood of a fraudulent transaction, and a zip code associated with the transaction.

In accordance with an embodiment, the top two records in the initial prediction data 218 are promoted to binary class 0. The initial predicted fraud probability value for zip code 11111 0.1 and the initial predicted fraud probability value for zip code 22222 is 0.2. Based on these values, it may be concluded that these transactions and transactions in these zip codes are likely not fraudulent. By promoting the records to binary class 0, the two records may be used in a ML model to extend the training dataset. Similarly, in accordance with an embodiment, the bottom two records in the initial prediction data 218 are promoted to binary class 1. The initial predicted fraud probability value for zip code 88888 is 0.8 and the initial predicted fraud probability value for zip code 99999 is 0.9. It may be concluded that these transactions and transactions in these zip codes are likely fraudulent. By promoting the records to binary class 1, the two records may be used in a ML model to augment the training dataset.

The subsequent prediction data 220 illustrates the effect of promoting the records in the initial prediction data 218. The initial prediction data 218 promoted records for zip code 11111 and zip code 22222 to binary class 0 or non-fraudulent. Subsequently, a record 222 for zip code 11111 and a record 224 for zip code 22222 will have their predicted probabilities, including probability 226 for record 222 and probability 228 for record 224, adjusted downward, from an initial fraud probability of 0.5 to fraud probabilities lower than 0.5. Similarly, a record 230 for zip code 55555 and a record 232 for zip code 66666 will have their predicted probabilities, including probability 234 for record 230 and probability 236 for record 232, adjusted upward, from an initial fraud probability of 0.5 to fraud probabilities greater than 0.5. Promoting one record will affect other records with similar data. After retraining with more data volume and categorical features, the new forecast could potentially yield clearer probability values.

FIG. 2C is a flow diagram illustrating an example, non-limiting embodiment of a method 240 of operation of categorical inference for training a machine learning model in accordance with various aspects described herein. The method 240 may be performed on any suitable data processing system including one or more processors and a memory. Examples of suitable systems for performing the method are described in conjunction with FIGS. 1 and 3-6.

The method 240 begins with loading a configuration file, block 242. The configuration file may be referred to as a Config file. The configuration file may be loaded from any suitable storage location, including by accessing the configuration file over a network. The configuration file stores information including initial parameters and settings and data. Further, the configuration file stores information such as promotion threshold values that may be used for training a ML model and using categorical inference. In some embodiments, the configuration file may be in the JavaScript Object Notation (JSON) format.

In one exemplary embodiment, the configuration file includes some or all of the following parameters:

Feature Parameters
1. Feature Name (fe_name)—Unique feature name to invoke feature logic.
2. Top Cutoff Value (parameters.top_cutoff)—Prediction records with propensity above this cutoff value will be promoted to a classification value of 1. The default value is 0.85.
3. Bottom Cutoff Value (parameters.bottom_cutoff)—Prediction records with propensity below this cutoff value will be demoted to a classification value of 0. The default value is 0.15.
4. Prediction Result Choice (parameters.result_choice)—Specify how the new prediction data will be combined with the old prediction data. The options are:
   1. Replace Prediction (replace)—Replace the old prediction data with the new prediction data. This is the default option.
   2. Average Prediction (average)—Take the average value between the old and new prediction
   3. Bias Negative (bias_neg)—Only replace the value where the new prediction is determined to be a binary classification value equal 0 (Negative Class).
   4. Bias Positive (bias_pos)—Only replace the value where the new prediction is determined to be a binary classification value equal 1 (Positive Class).
5. Warm Restart (parameters.warm_restart)—Whether to retrain the model from the currently feature engineered data (TRUE) or start from the initial raw datasets (FALSE). The default value is FALSE.
6. Iteration (parameters.iteration)—The number of times to recursively apply this feature logic. The default value is 1.
7. Early Stop Length (parameters.early_stop_len)—Stop the iteration early if the total new records discovered falls below the indicated threshold.

Other parameters may be established and used as well in other embodiments.

At step 244, under control of the configuration file, training data is loaded. The training data includes the original raw data to be used for fitting or training the ML model. The raw data may be collected from any suitable source and includes a plurality of data records. In some embodiments, for parameter tuning and algorithms searching, this dataset may be further sub-sampled into multiple fragments. This process is known as cross validation. Out of those sub-sampled fragments, one will be chosen to be the testing data while the remaining are treated as training data. In this example embodiment, the word “training” data is used loosely to describe various versions of the training data frame as it is passed thru a feature engineering process up to fitting the model. While the raw training data, after 1st feature, 2nd feature, . . . Nth feature, will have different values, they are collectively referred to as training data.

At step 246, under control of the configuration file, testing data is loaded. This corresponds to the original, raw data to be fed into the trained model to obtain the prediction. In some embodiments, the word “testing” data is used loosely to describe various versions of the testing data frame as it passed thru the feature engineering process up to model prediction. While the raw testing data, testing data after 1st feature, 2nd feature, . . . Nth feature will have different values, they are collectively called testing data.

At step 248, a feature engineering process occurs. The feature engineering process includes applying appropriate feature engineering rules to training data and applying appropriate feature engineering rules to test data. In one example, the training data may be filtered or formatted to a more appropriate form. In another example, the training data may be modified or reformatted to better represent underlying problems of the particular situation the ML model is intended to identify and understand. The result of the feature engineering process is engineered data.

At step 250, the ML model is trained. The ML model is fit with engineered data produced by the feature engineering process at step 248. The model algorithms and parameter tuning options are appropriately determined by the configuration file. In some embodiments, the configuration file includes an algorithms section that defines the list of algorithms supported, along with Hyperparameters and Best parameters. In some embodiments, the configuration file includes a Select Algorithms (usecase.select_alg) process that selects a list of algorithms to be included in the model execution flow.

At step 252, a prediction operation is performed. The prediction operation obtains the initial propensity prediction with value between [0 .. 1]. The result is prediction data. FIG. 2A and FIG. 2B illustrate exemplary prediction data.

At step 254, a binary promotion function is performed on the prediction data produced by the prediction process at step 252. In some embodiments, the binary promotion function operates to promote records in the prediction data with a propensity value above a variable designated as Top Cutoff threshold. Records with a propensity above the Top Cutoff threshold value are assigned to a classification value of 1, or to a Positive Class. The Top Cutoff threshold value may be set by in the configuration file as parameters.top_cutoff. In one example, the Top Cutoff threshold is set at 0.85. In the example of FIG. 2A, record 204 has a probability of 0.95 and exceeds the Top Cutoff threshold and therefore is promoted to a classification value of 1. Similarly, record 210 has a probability value of 0.89 and exceeds the Top Cutoff threshold and therefore is promoted to a classification value of 1.

Also at step 254, in some embodiments, the promotion function operates to promote records in the prediction data with a propensity value below a variable designated as Bottom Cutoff threshold. Records with a propensity value below the Bottom Cutoff threshold are assigned to a classification value of 0, or to a Negative Class. The Bottom Cutoff threshold value may be set by in the configuration file as (parameters.bottom_cutoff). In one example, the Bottom Cutoff threshold value is set to 0.15. In the example of FIG. 2A, records 206 has a probability value of 0.12 and is below the Bottom Cutoff threshold and therefore is promoted to a classification value of 0. Similarly, the record 214 has a probability value of 0.05 and is below the Bottom Cutoff threshold and therefore is promoted to a classification value of 0.

In some embodiments, only prediction data records with a propensity value exceeding the Top Cutoff threshold are promoted to a classification value of 1. In some embodiments, only prediction data records with a propensity value below the Bottom Cutoff threshold are promoted to a classification value of 0. In some embodiments, both predication data records exceeding the Top Cutoff threshold and prediction data records below the Bottom Cutoff threshold are promoted appropriately. The selection of which prediction data records may be promoted may be programmed, for example, by parameters or other data of the configuration file. By selecting which prediction data records are promoted, a customized process may be implement and an improved forecast may be obtained.

In some embodiments, the Top Cutoff threshold value or the Bottom Cutoff threshold value, or both may be adjusted. For example, the threshold values may be configured manually or automatically. Automatic configuration of the threshold values may be controlled by logic of the configuration filed. This may be done, for example, to prevent bias influences. That is, if too many prediction values are promoted, there may be an excessive bias introduced in the ML model. If a bias influence is detected, the Top Cutoff threshold or the Bottom Cutoff threshold, or both, may be adjusted. For example, the Top Cutoff threshold may be adjusted from a default value such as 0.85 to an adjusted value of 0.90. Similarly, the Bottom Cutoff threshold value may be adjusted from a default value such as 0.15 to 0.10. Adjusting the Top Cutoff threshold to a larger value (i.e., closer to 1) and adjusting the Bottom Cutoff threshold to a smaller value (i.e., closer to 0) will tend to reduce the number of prediction records that get promoted by the binary promotion process.

The binary promotion function produces an affected fragment 256 and a remain fragment 258. The affected fragment 256 includes the selected prediction records from the Binary Promotion and Demotion process of step 254. The remain fragment 258 includes the remaining prediction records of the prediction data produced by the prediction process at step 252 not in the affected fragment 256.

As an example, assume the initial test data at step 246 included 100,000 records. After training the model, step 250 and after the prediction process at step 252, the binary promotion process at step 254 concludes that 20,000 of the records are likely susceptible to customer churn or are like not susceptible to customer churn. The 20,000 records that are promoted form the affected fragment 256. Those are added to the training data to form the new training data at step 260. The data of the affected fragment 256 are considered to be actual values for the second pass. The 80,000 records that were promoted and that remain after the 20,000 records of the affected fragment 256 are removed from the original test data from step 246 then form the remain fragment 258. The 80,000 records are then fed back for the second pass to determine if, by changing the assumptions, the model provides any further insight.

At step 260, new training data is produced by combining the data of the affected fragment 256 with the training data from step 244 to form the new training data. The new training data is the training data from step 244 augmented with promoted records from the prediction data. The number of records in the new training data should grow after each iteration.

At step 262, new test data is produced by subtracting the data of the remain fragment 258 from the test data produced at step 246 to form the new testing data. The number of records in the new testing data should shrink after each iteration.

At step 268, a second pass operation is performed. Based on the configuration file option Warm Restart (parameters.warm_restart), we can route the new training data and the new testing data to either the feature engineering process of step 248 or straight to model fitting or model training, at step 250.

Generation of the prediction data by the prediction process at step 252 represents a first pass through the ML model. In accordance with the subject disclosure, a second pass through the ML model occurs. The second pass through the ML model employs the new training data from step 260. The new training data include training date from step 244, augmented with the promoted records from the binary promotion process at step 254.

Two possible data flows exist for second pass processing. The new training data and the new testing data can be subject to the feature engineering process at step 248, or can bypass the feature engineering process at step 248. If the new training data and new testing data are provided to the feature engineering process at step 248, the new training data and the new testing data may be subjected to the complete feature engineering process. It is assumed that the new training data will carry more insight or more variables that have not previously been discovered in the prior pass or that were dropped due to factors such as train/test-mirror constraints. This option will add more time to the total execution but will maximize the benefit of this algorithm, that of gaining more data insights. This is the best option if the data are imbalanced data, where there is a disproportionate ratio of observations in each class, or where the classes are not represented equally. After the feature engineering process, step 248, control proceeds to train the model at step 250.

Depending on the configuration settings, the new training data and the new testing data may be sent directly to the train model operation, step 250, bypassing the feature engineering process at step 248. It is assumed in this case that there will not be much more new insight or variables obtained than what is already available. This is a good tradeoff for execution time vs. data insight gains if the data are balanced data.

Flow proceeds to the second pass prediction process, step 266. The prediction operation of step 266 is performed on the prediction from the first iteration of the algorithm. This is also considered the prediction from the second pass of the model. Further iterations beyond the second pass may be performed under control of the variable of the N-Iteration process at step 268. The N-Iteration process at step 268 includes logic to recursively iterate through the model as needed.

Following the second pass and subsequent passes through the ML, model, the prediction results may be combined in any suitable manner. In some embodiments, the configuration file defines possible prediction result options. Possible prediction result options are exemplary combinations of the promoted prediction records from the second pass through the ML model and existing prediction records from the first pass through the ML model. A first option 270 is Average Positive, or take the average of the prior prediction and the new prediction where the Record ID matched up and the new prediction classification has a value of 1 (Positive Class). A second option 272 is Replace Positive, or replace only records from the prior prediction with records from the new prediction where the Record ID matched up and the new prediction classification has a value of 1 (Positive Class). A third option 274 is Average Negative, or take the average of the prior prediction and the new prediction where the Record ID matched up and the new prediction has a classification value of 0 (Negative Class).

A fourth option 276 is Replace Negative, or replace only records from prior the prediction with records from the new prediction where the Record ID matched up and the new prediction classification has a value of 0 (Negative Class). A fifth option 278 is Replace Prediction or replace all records from the prior prediction with records from the new prediction where the Record ID matched up. A sixth option 280 is Average Prediction, or take the average of the prior prediction and the new prediction where the Record ID matched up.

FIG. 2D depicts an illustrative embodiment of a method 282 in accordance with various aspects described herein. In exemplary embodiments, the method 240 of FIG. 2C may be performed as either a batch process or as a real-time process, for example to identify consumer churn or customer fraud by a telecommunication service provider. The method 240 is useful when operated as a batch process using relatively large numbers of records. The affected fragment 256 may have a relatively large number of records so that when the records of the affected fragment 256 are added to the training data to augment the training data and form the new training data, new insight and information results from the operation of the ML model.

In the case of a real time process, however, the affected fragment 256 may only include a relatively small number of records. The number of records promoted by the binary promotion process at step 254 may be insufficient to draw meaningful or reliable conclusions. Accordingly, the records promoted by the binary promotion process at step 254 may preferably be accumulated over a time period and then a batch process may be run to re-train the model. However, some situations, such as consumer fraud, require real-time, or near-real-time, response. The term real-time depends on the circumstances, but generally means an issue that requires prompt attention, or attention within an amount of time to provide an effective response. Examples include one day for retail or business transaction, in order to reverse a fraudulent transaction.

In the method 282, training data from step 244 is used in a training process at step 250 to train a machine learning (ML) model 284. Test data from step 246 is provided to the ML model 284. These features may be substantially in accordance with features and processes described above in conjunction with method 240 in FIG. 2C. The ML model 284 produces prediction data 286. FIG. 2A and FIG. 2B illustrate exemplary prediction data. The ML model 284 may be run in two passes or more than two passes, as described in conjunction with FIG. 2C.

At block 288, a real-time or near-real-time action may be taken based on the output of the ML model 284 and/or the prediction data. For example, in the case of identification or detection of consumer fraud, new data may be provided to the ML model 284 each day. The new data may include records of transactions by a communication service provider with customers over the course of one day. Some of those transactions may be fraudulent in nature, such as a product sold or exchanged on a fraudulent basis. The ML model 284 may predict one or more fraudulent transactions involving a product that is the subject of a retail transaction. If so, the real-time action at step 288 should include further investigation to identify if the transaction was truly fraudulent and, if so, to take appropriate action. Such appropriate action may include suspension of a customer account, contacting the customer, retrieving a product that was the subject of the fraudulent transaction, etc. For example, if a new SIM card was fraudulently exchanged for a new SIM card by a customer, the new SIM card may be retrieved from the customer. If investigation discloses that the suspected transaction was not fraudulent, no further action need be taken. However, in some example embodiments, real-time action is desirable, such as response to possible fraud.

When processing transaction records for a single day, or any relatively short duration, the affected fragment 256 (FIG. 2C) produced by the binary promotion process at step 254 may include only a few records. For efficiency and maximum effectiveness, the method 240 may preferably be run as a batch process. Accordingly, at step 290, promoted records are accumulated. For example, each day's retail transaction records may be accumulated over a predetermined period of time, such as one week or one month or one fiscal quarter. The records may be stored in any suitable memory or database.

At step 294, the method determines if retraining the model is now appropriate. Retraining the ML model 284 may be done on a regular basis, such as monthly. In other examples, the ML model 284 may be retrained when the number of accumulated, promoted records exceeds a predetermined threshold. The predetermined threshold may be set dynamically, depending on factors such as the number of records in the affected fragment, etc.

If it is determined at step 294 that it is not yet time to retrain the ML model 284, a periodic update occurs, step 296. In one example, the periodic update is receiving and processing daily transaction records for transactions with customers of the communication service provider. Those records may be used, for example, to predict fraudulent transaction. In another example, those records may be used to predict consumer churn.

If it is determined at step 294 retraining the ML model 284 is appropriate, the accumulated promoted records from step 290 are added to the training data from step 244 to create the new training data at step 260. At step 298, the ML model is retained with the new training data at step 260.

While for purposes of simplicity of explanation, the respective processes are shown and described as a series of blocks in FIG. 2C and FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

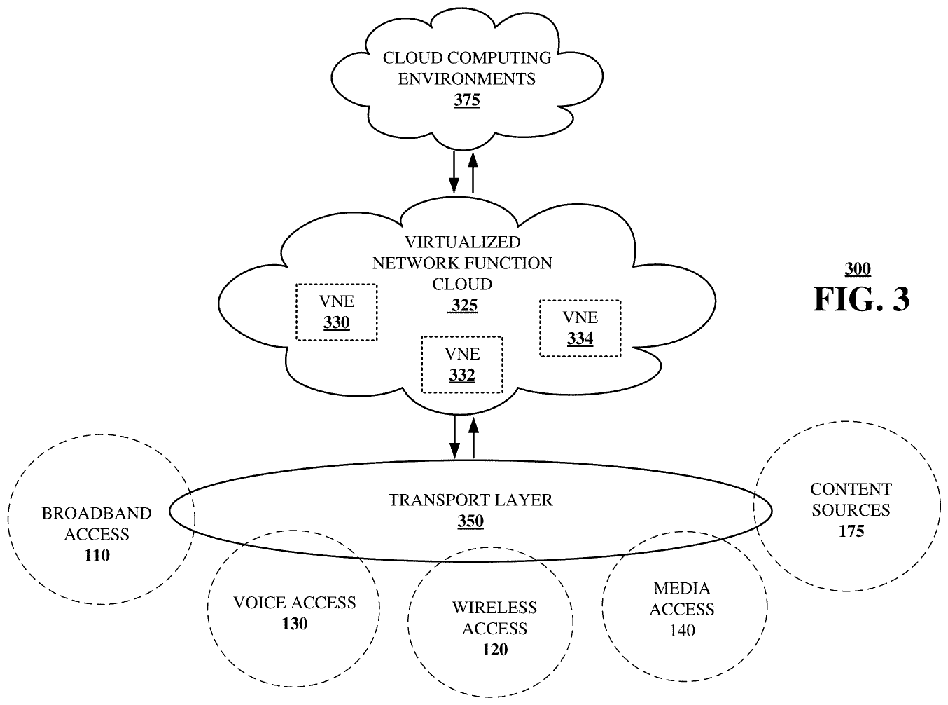

Referring now to FIG. 3, a block diagram is shown illustrating an example, non-limiting embodiment of a virtualized communication network 300 in accordance with various aspects described herein. In particular a virtualized communication network 300 is presented that can be used to implement some or all of the subsystems and functions of system 100, the subsystems and functions of method 240 and method 282 presented in FIGS. 1, 2A, 2B, 2C and 2D, and 3. For example, virtualized communication network 300 can facilitate in whole or in part implementing a machine learning model to generate predictions about a real-world system, identify a problem requiring resolution, and resolve the problem. In particular, the virtualized communication network 300 can facilitate multiple pass training and prediction in a machine learning model, including selectively promoting predicted data records having a prediction possibility close to binary true and false values, and using the promoted records to enrich the training data for a second pass and subsequent passes through the machine learning model.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

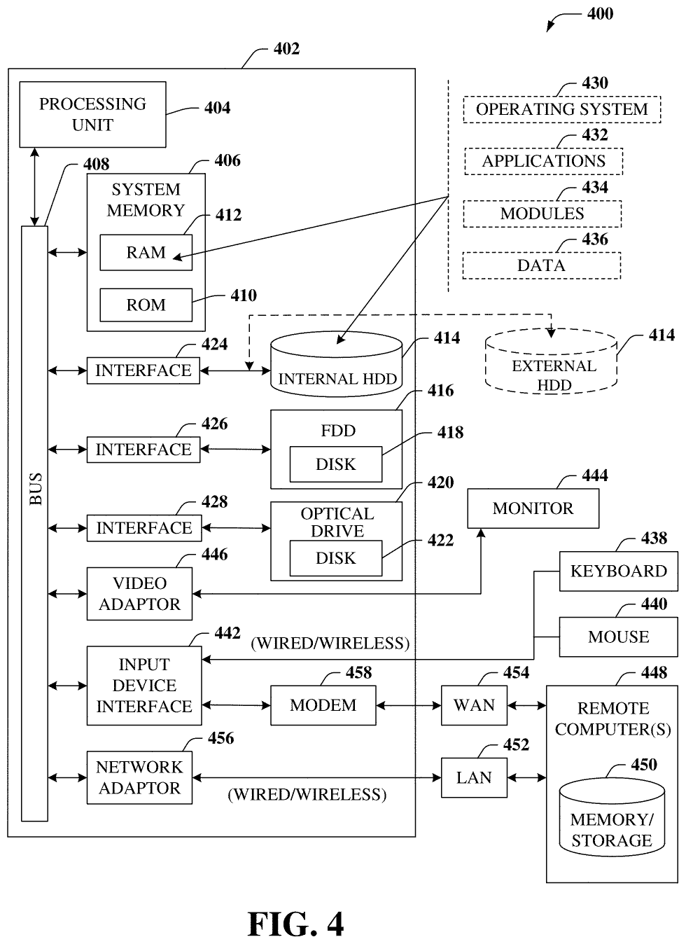

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in implementing a machine learning model to generate predictions about a real-world system, identify a problem requiring resolution, and resolve the problem. In particular, the computing environment 400 can facilitate multiple pass training and prediction in a machine learning model, including selectively promoting predicted data records having a prediction possibility close to binary true and false values, and using the promoted records to enrich the training data for a second pass and subsequent passes through the machine learning model.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in some embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

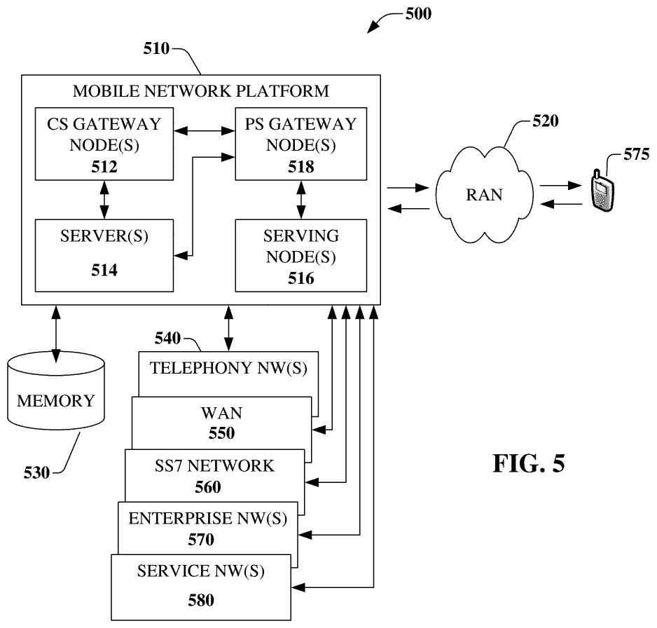

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part implementing a machine learning model to generate predictions about a real-world system, identify a problem requiring resolution, and resolve the problem. In particular, the mobile network platform 510 can facilitate multiple pass training and prediction in a machine learning model, including selectively promoting predicted data records having a prediction possibility close to binary true and false values, and using the promoted records to enrich the training data for a second pass and subsequent passes through the machine learning model.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway nodes 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

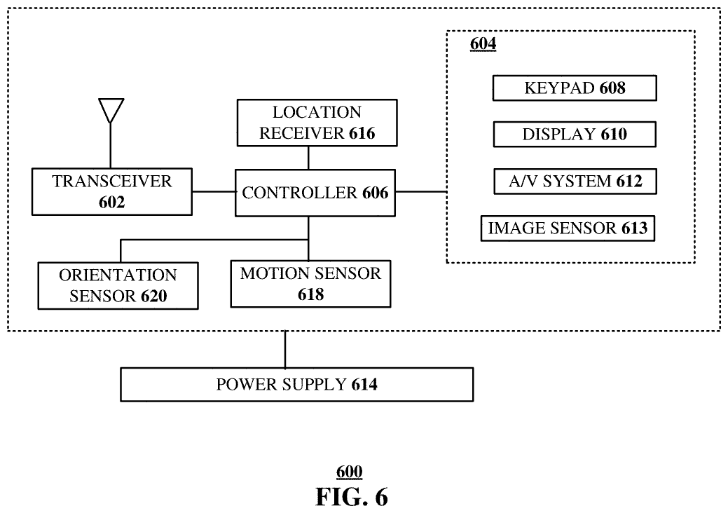

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part implementing a machine learning model to generate predictions about a real-world system, identify a problem requiring resolution, and resolve the problem. In particular, the computing device 600 can facilitate multiple pass training and prediction in a machine learning model, including selectively promoting predicted data records having a prediction possibility close to binary true and false values, and using the promoted records to enrich the training data for a second pass and subsequent passes through the machine learning model.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
training a machine learning model on training data;
generating, by the machine learning model, a plurality of prediction data records, each prediction data record of the plurality of prediction data records having an associated probability;
promoting prediction data records of the plurality of prediction data records having an associated probability exceeding a threshold, forming promoted prediction data records;
combining the promoted prediction data records with the training data, forming new training data;
re-training the machine learning model on the new training data;
generating, by the machine learning model, new prediction data records;
based on the new prediction data records, identifying a real-time condition, wherein the real-time condition requires prompt attention; and
resolving the real-time condition.

2. The device of claim 1, wherein the identifying the real-time condition comprises identifying a fraudulent retail transaction and wherein resolving the real-time condition comprises retrieving from a retail customer a product related to the fraudulent retail transaction.

3. The device of claim 1 wherein the promoting prediction data records comprises:
for each respective prediction data record of the plurality of prediction data records, comparing a respective associated probability with a threshold; and
promoting the respective prediction data record to a binary class 1 in response to the respective associated probability exceeding the threshold.

4. The device of claim 3, wherein the operations further comprise:
selecting a value for the threshold for the comparing.

5. The device of claim 1 wherein the promoting prediction data records comprises:
for each respective prediction data record of the plurality of prediction data records, comparing a respective associated probability with a top cutoff threshold;
promoting the respective prediction data record to a binary class 1 in response to the respective associated probability exceeding the top cutoff threshold;
comparing a respective associated probability with a bottom cutoff threshold; and
promoting the respective prediction data record to a binary class 0 in response to the respective associated probability failing to exceed the bottom cutoff threshold.

6. The device of claim 5, wherein the operations further comprise:
selecting a value for the top cutoff threshold; and
selecting a value for the bottom cutoff threshold.

7. The device of claim 1, wherein the operations further comprise:
combining the new prediction data records with the plurality of prediction data records.

8. The device of claim 7, wherein the combining the new prediction data records with the plurality of prediction data records comprises:
replacing some or all respective prediction data records of the plurality of prediction data records with respective new prediction data records in response to a respective new prediction data record having a record identifier matching a record identifier of a respective prediction data record, to produce prediction result records.

9. The device of claim 7, wherein the combining the new prediction data records with the plurality of prediction data records comprises:
averaging respective prediction data records of the plurality of prediction data records with respective new prediction data records, in response to a respective new prediction data record having a record identifier matching a record identifier of a respective prediction data record, to produce prediction result records.

10. A machine-readable medium, comprising executable instructions that, when executed by a processing system including a processor, facilitate performance of operations, the operations comprising:
training a machine learning model with training data, the training data including a plurality of data records;
applying testing data to the machine learning model in a first pass to generate first-pass prediction data records, each respective first pass prediction data record having a respective associated probability value;
selectively promoting first pass prediction records in response to a respective associated probability value of a respective first pass prediction record exceeding a threshold, producing promoted prediction records;
combining the promoted prediction records with at least some data records of the training data, producing new training data;
training the machine learning model with the new training data;
applying at least a portion of the testing data to the machine learning model in a second pass to generate second pass prediction data records; each respective second pass prediction data record having a respective associated second pass probability value; and
combining respective second pass prediction data records with respective first pass prediction data records, forming prediction result records.

11. The machine-readable medium of claim 10, wherein the promoting the first pass prediction records comprises:
for each respective first pass prediction record of the first pass prediction records,
comparing a respective associated probability with a top cutoff threshold;
promoting the respective first pass prediction record to a binary class 1 in response to the respective associated probability exceeding a top cutoff threshold;
comparing the respective associated probability with a bottom cutoff threshold; and
promoting the respective first pass prediction record to a binary class 0 in response to the respective associated probability failing to exceed a bottom cutoff threshold.

12. The machine-readable medium of claim 11, wherein the operations further comprise:
based on the prediction result records, identifying a suspected fraudulent retail transaction among the training data or the testing data; and
retrieving from a retail customer a product related to the suspected fraudulent retail transaction.

13. The machine-readable medium of claim 11, wherein the operations further comprise:
selecting a value for the top cutoff threshold; and
selecting a value for the bottom cutoff threshold.

14. The machine-readable medium of claim 13, wherein the operations further comprise:
adjusting the top cutoff threshold, the bottom cutoff threshold, or both, to reduce bias effects in the machine learning model.

15. The machine-readable medium of claim 10, wherein the combining the respective second pass prediction records with the respective first pass prediction data records comprises:
replacing some or all respective first pass prediction records with respective second pass prediction data records in response to a respective second prediction record having a record identifier matching a record identifier of a respective first pass prediction record, to form the prediction result records.

16. The machine-readable medium of claim 10, wherein the combining the respective second pass prediction records with the respective first pass prediction data records comprises:
averaging respective first pass prediction records with respective second prediction data records, in response to a respective second prediction record having a record identifier matching a record identifier of a respective first pass prediction record, to form the prediction result records.

17. A method, comprising:
receiving, by a processing system including a processor, data for a plurality of interactions;
selecting, by the processing system, a first set of the data, forming training data;
the training data including a plurality of data records;
selecting, by the processing system, a second set of the data, forming testing data;
training, by the processing system, a machine learning model with the training data;
applying, by the processing system, the testing data to the machine learning model in a first pass to generate first pass prediction records, each respective first pass prediction record having a respective associated probability value;
comparing, by the processing system, respective associated probability values of respective first pass prediction records with one or more cutoff thresholds;
promoting, by the processing system, respective first pass prediction records in response to the comparing, producing an affected fragment of prediction records;
combining, by the processing system, the affected fragment of prediction records with at least some data records of the training data, producing new training data;
training, by the processing system, the machine learning model with the new training data;
applying, by the processing system, at least a portion of the testing data to the machine learning model in a second pass to generate second pass prediction data records;
each respective second pass prediction data record having a respective associated second pass probability value; and
combining, by the processing system, respective second pass prediction data records with respective first pass prediction data records forming prediction result records.

18. The method of claim 17, further comprising:
removing, by the processing system, the affected fragment of prediction records from the first pass prediction records, producing a remaining fragment of prediction records; and
removing, by the processing system, the remaining fragment of prediction records from the testing data, forming new testing data; and
applying, by the processing system, the new testing data, to the machine learning model in a second pass to generate the second pass prediction data records.

19. The method of claim 17, further comprising:
selecting, by the processing system, the one or more cutoff thresholds, to reduce bias effects in the machine learning model.

20. The method of claim 17, comprising:
based on the prediction result records, identifying, by the processing system, a suspected fraudulent retail transaction among the training data or the testing data; and
initiating, by the processing system, a retrieval, from a retail customer, a product related to the suspected retail fraudulent transaction.
